(19) United States
(12) Patent Application Publication
(10) Pub. No.: US 2020/0364711 A1
(43) Pub. Date: Nov. 19, 2020

(54) Transaction Processing with Merged Token and Cryptogram

(71) Applicant: PayPal, Inc., San Jose, CA (US)

(72) Inventor: Pankaj Sarin, Elkhorn, NE (US)

(21) Appl. No.: 16/413,427

(22) Filed: May 15, 2019

(51) Int. Cl. G06Q 20/40; H04L 9/32

(52) U.S. Cl. CPC G06Q 20/401; G06Q 2220/00; H04L 2209/56; H04L 9/3228

(57) ABSTRACT

Various systems and methods utilizing different formats for authorization data for transactions are disclosed. A computer system of a payment service provider receives a first request for a transaction having a first set of authorization data in a first format. The computer system may then determine to format the first set of authorization data into a second set in a second, different format. The computer system sends the second set of authorization data to a device of a user requesting the transaction. Subsequently, the computer system receives a second request for the transaction including the second set of authorization data, and then processes the second request for the transaction.

### BACKGROUND

### Technical Field

This disclosure is directed to payment processing systems, and more particularly, to data values conveyed between various entities in a payment processing system.

### Description of the Related Art

Payment service providers are commonly used in conducting electronic payments. Such payment service providers may provide services for a number of different payment methods. Such methods may include credit card transactions and debiting of bank accounts, among others.

In some payment methods, tokenization may be utilized. Tokenization is a security mechanism in which a token is conveyed instead of a user's financial information (such as a bank account number or credit card number). On its own, the token may have no intrinsic meaning, and thus its interception does not compromise the user. Instead, the token maps back to the user's financial information. In order to achieve such mapping, a construct known as a cryptogram may be separately conveyed during the transaction, the cryptogram being associated with the token. When decrypted, the cryptogram is used to associate the token with the user's account information, thereby allowing the transaction to be processed.

### SUMMARY

Various embodiments utilizing different formats for authorization data for transactions are disclosed. In one embodiment, a computer system of a payment service provider receives a first request for a transaction having a first set of authorization data in a first format. The computer system may then determine to format the first set of authorization data into a second set in a second, different format. The computer system sends the second set of authorization data to a device of a user requesting the transaction. Subsequently, the computer system receives a second request for the transaction including the second set of authorization data, and then processes the second request for the transaction.

In one embodiment, the first format of authorization data includes a token and a separate cryptogram that are conveyed to the computer system of the payment services provider. The token serves as a stand-in for the user's financial information (e.g., account number, financial institution, etc.), while the cryptogram is decrypted to map the token back to the user's financial information. The second format of authorization, in such an embodiment, may include a single data value into which the token and the cryptogram are merged. The merging of the token and cryptogram may provide additional security over their unmerged counterparts. The determination to use the second format may be based on any of various factors, including a risk assessment of the transaction, the type of financial instrument being used for the transaction, etc.

### BRIEF DESCRIPTION OF THE DRAWINGS

The following detailed description makes reference to the accompanying drawings, which are now briefly described.

FIG. 1A is a block diagram illustrating operations carried out by one embodiment of a computer of a payment services provider for processing a transaction using first and second different formats.

FIG. 1B is a block diagram of one embodiment of a computer system of a token service provider.

FIG. 2 is a block diagram of one embodiment of a payment processing system.

FIG. 3 is a block diagram of one embodiment of a user device from which transactions may be initiated.

FIG. 4 is a block diagram of one embodiment of a computer system of a payment services provider.

FIG. 5 is a block diagram of another embodiment of a computer system of a token service provider.

FIG. 6 is a block diagram of one embodiment of a demerge module implemented by a computer system of a token service provider.

FIG. 7 is a block diagram illustrating various protocols for merging a token and a cryptogram into a single data value.

FIG. 8 is a block diagram illustrating the flow of a transaction that is first attempted with a separate token and cryptogram, followed by a second attempt with the token and cryptogram merged in a single data value.

FIG. 9 is a flow diagram illustrating one embodiment of a method for conducting a transaction from the perspective of a computer system of a payment services provider.

FIG. 10 is a flow diagram illustrating an embodiment of a method for merging a token and a cryptogram into a common data value.

FIG. 11 is a flow diagram illustrating embodiment of a method for conducting a transaction from the perspective of a computer system in a token service provider.

FIG. 12 is a block diagram of one embodiment of an example computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a system having multiple protocols for merging data values, “first” and “second” merge protocols may refer to any particular ones of the multiple protocols.

When used in the claims, the term “or” is used as an inclusive or and not as an exclusive or. For example, the phrase “at least one of x, y, or z” means any one of x, y, and z, as well as any combination thereof.

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION OF EMBODIMENTS

The present disclosure is directed to various method and apparatus embodiments in which transactions may be conducted using a different data format for at least some transactions with respect to the format used in other transactions. In one embodiment, a first format may include conveying a token and a cryptogram separately from one another, while a second format may include conveying a common data value that includes a token and a cryptogram merged together. In some cases, these transactions are financial transactions.

Tokenization is the process of replacing a user's financial information (e.g., a credit card number) with an arbitrary number that, in effect, secures the financial information while in transfer over the payment network, as the token data has no intrinsic meaning. For many transactions, a cryptogram may be conveyed separate from the token. The cryptogram includes unique authentication data generated by a user's device (e.g., a smart phone). Generation of the cryptogram may be performed in conjunction with a cryptographic key, which can be a static key or a dynamic key. Authentication of the token includes decryption of the cryptogram, and demonstrates that the financial information and the user device are genuine and not a vehicle for intercepted or cloned credentials. The present disclosure contemplates the merging of the token and the cryptogram into single data value for at least some transactions in order to achieve higher security for transactions. A token service provider may, upon receiving the single data value having a merged token and cryptogram, perform various functions including decryption, demerging (separating) the token from the cryptogram, and the performing of various other tasks associated with associating the token to a user's account in order to continue processing the transaction.

Utilization of a data value comprising a merged token and cryptogram may be useful in enhancing the overall security of transactions using the same. The merging of a token and a cryptogram into a single data value may be conducted according to protocols that may vary from one “tenant” to the next. As described below, the term “tenant” in this disclosure is used to refer to tenants of a payment services provider (e.g., VENMO may be a tenant of PAYPAL when the latter acts as a payment services provider), as well as to different issuer financial institutions (e.g., VISA and MASTERCARD may be different issuer tenants). Thus, a token and a cryptogram may be merged according to a first protocol for a first credit card issuer and merged according to a second, different protocol for a second credit card issuer. Such protocols can include concatenating a token with a cryptogram, or various levels of interleaving token data and cryptogram data. Processing of a transaction utilizing the merged token and cryptogram thus includes demerging of the token and the cryptogram in addition to performing decryption to authenticate the token and associate it with the user's financial information. Accordingly, the need to demerge the token from the cryptogram in order to process the transaction using the same thus adds another layer of security. Conveying the token and the cryptogram in a single data value may also reduce the use of network resources since only a single data value is transmitted rather than two separate data values.

In various embodiments, an initial transaction request (i.e., one utilizing token separate from a corresponding cryptogram) may undergo an analysis (which may include a risk assessment), which may be conducted by a payment services provider. In certain embodiments, a payment services provider may take one of three actions based on the analysis: (1) pre-approving the transaction, thus allowing further processing the transaction with the unmerged (separate) token and cryptogram, (2) declining the transaction, or (3) forcing a retry of the transaction after causing merging the token and the cryptogram into a single data value. If the payment services provider determines that a transaction is to be retried, for example based on a risk assessment, the token and the cryptogram are merged into a single data value according to a selected merge protocol. As noted above, the merge protocol selected for merging the token and the cryptogram may depend at least in part on specified merge rules. After completing the merging of a token and a cryptogram, the payment services provider may convey the merged data value to a device of the user from which the original transaction was generated, and the transaction may be retried from that point. Typically, the retry of the transaction happens quickly and is opaque to the user and merchant.

In various embodiments, different computer systems within entities may implement various “modules.” As used herein, the term “module” refers to circuitry configured to perform specified operations, or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

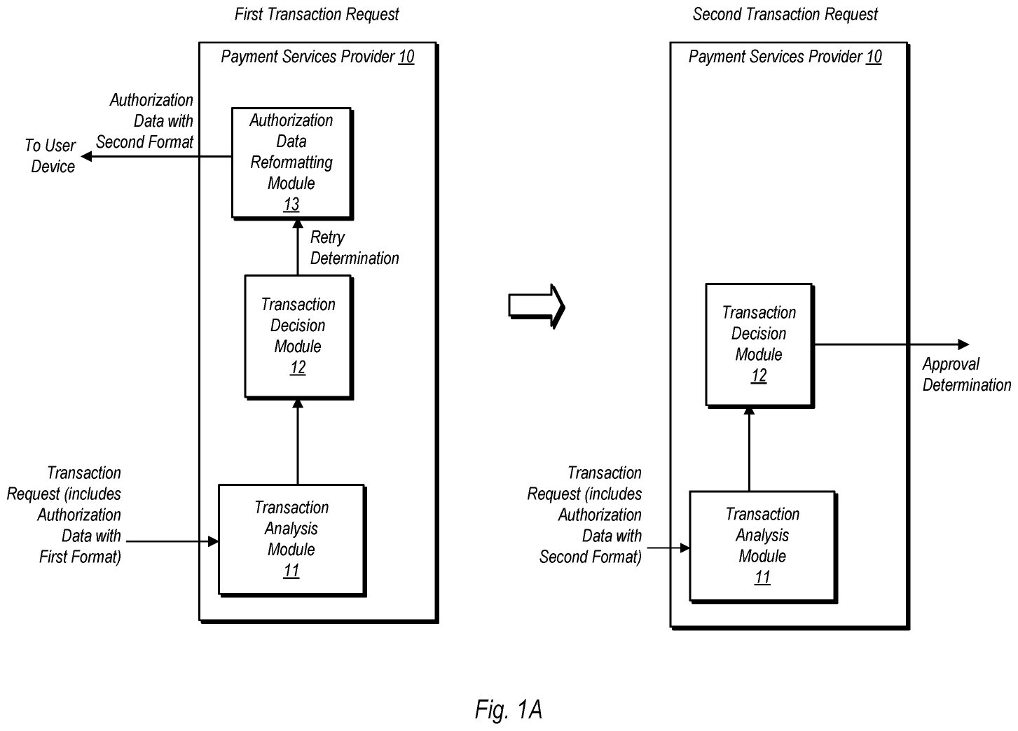

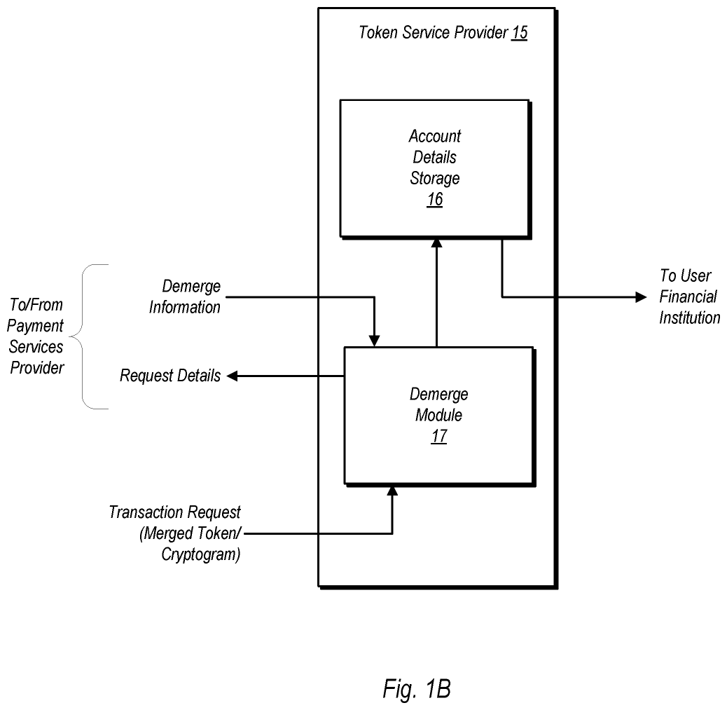

Turning now to FIG. 1A, a block diagram illustrating operations carried out by one embodiment of a computer of a payment services provider for processing a transaction using first and second formats. As used herein, “payment services provider” is used according to its accepted meaning in the art, which includes an entity whose systems merchants connect to in order to facilitate processing of financial transactions by providing connections to various entities involved in such transactions, including merchants, consumers, financial institutions, card networks, etc.

In the embodiment shown, various functional entities implemented in a computer system of payment services provider 10 may perform various functions to enable processing of a transaction according to different formats. The first and second transaction requests as shown herein refer to, in this example, a transaction originally attempted using authorization data in a first format, and subsequently re-attempted using authorization data in a second format. Examples of the first and second formats and the reasons for a retry of the transaction are discussed in further detail below.

In a first transaction request, payment services provider 10 may receive, at transaction analysis module, a first transaction request 11 including authorization data having a first format. The first format may include a token and a corresponding cryptogram that are conveyed separately from one another—that is, as distinct data values. The notion of “separate” or “distinct” data values means that they are transmitted and received in a manner in which they are distinguishable as different entities (e.g., different variables). For example, the token and cryptogram may be conveyed within separate packets, with the token being included in the payload of a first packet and the cryptogram being included in the payload of a second packet. Alternately, the token and cryptogram might be included in the same payload as two separate objects.

The transaction analysis module 11 may perform various assessments of transaction, such as performing a risk assessment. A risk assessment function can be used to govern the payment processing outcome, whether that constitutes success, failure, placing a hold on transaction because of the risk scores computed by the assessment, etc. The risk scores may be determined using pre- and post-transaction variables such as past unauthorized payment attempts from the device, propensity of transaction fraud given merchant location or point-of-sale device, etc. The risk assessment score can also be shared with other tenants of the payment service provider to secure transaction processing and minimize transaction losses. In general, module 11 may perform any suitable type of analysis or gather any pertinent type of information about the transaction. For example, module 11 may determine identifying information regarding a particular “tenant” of payment services provider 10 or a particular financial instrument being used for the transaction (e.g., VISA credit card). The information generated by transaction analysis module 11 may then be conveyed to transaction decision module 12. In the embodiment shown, transaction decision module 12 makes a determination regarding the transaction by applying a set of rules that operate based on information provided by module 11. (Note that in some embodiments, modules 11 and 12 may be the same; the modules are shown separately to illustrate the potentially distinct actions of gathering or determining information about a transaction and then making a decision about that transaction based on this information.)

Various types of decisions may be made by module 12. In the embodiment shown, module 12 can make one of three determinations for a transaction: allow the transaction to proceed, decline the transaction, retry the transaction. Note that allowing the transaction to proceed does not mean final approval; this could be a “pre-approval” that simply indicates that the transaction is allowed to continue through the payment network (where it could ultimately be finally approved or declined). Declining a transaction may be appropriate, for example, if transaction analysis module 11 determines that the transaction is too risky to proceed. Alternately, decision module 12 may determine that the transaction needs to be retried (as shown in FIG. 1A). Note that, according to the present disclosure, the transaction may be retried for any suitable reason. As one example, a transaction may be retried based on the risk assessment falling into an intermediate area between allowing the transaction to proceed and declining the transaction.

This retry determination, according to certain embodiments, may be an indication that the retry is to be performed in a different manner than the original request. For example, as illustrated, when transaction decision module 12 makes the retry determination, authorization data reformatting module 13 may reformat the authorization data into a second, different format. As used herein, a “different format” refers to a different way of packaging or arranging the constituent authorization data such that a receiving entity will need to use different logic to extract the authorization data in the first and second formats. In various embodiments to be discussed below, reformatting the authorization data from a first format into a second format includes merging the token and the cryptogram from separate data values in the first format into a single data value in the second format. The manner of reformatting the authorization data may vary from one embodiment to another. After completion of the reformatting, the authorization data having the second format is conveyed to a user device such that the transaction may be retried. This paradigm may improve security and reduce network traffic.

The right-hand portion of FIG. 1A illustrates a second transaction request that is performed, in one embodiment, responsive to a retry determination for the first transaction request. As indicated, the second transaction request is performed using authorization data having a different format than in the first transaction request—for example, the first transaction request may include separate tokens and cryptograms, while the second transaction request may include a merged token/cryptogram. In this example, the transaction request having the second format is received by payment services provider at transaction analysis module 11. Transaction analysis module 11, as previously described, can generate or access various types of information regarding the transaction, including conducting another risk assessment, determining a type of financial instrument, etc. This information is then passed to decision module 12, which determines if the transaction should proceed. As noted, module 12 may determine that the transaction should proceed, be denied, etc. Note that it is possible for a transaction to ultimately be denied by module 12 even after a retry within a merged token/cryptogram. In FIG. 1A, however, a scenario is shown in which transaction decision module 11 indicates that the transaction is approved, meaning that it can proceed within the payment network.

In some embodiments, the merged token/cryptogram may be used selectively (as described with reference to FIG. 1A); in other embodiments, the merged/token cryptogram for all transactions by an initiating event. In either instance, a transaction request will ultimately reach a “token service provider,” which is a computer system configured to receive authorization data (e.g., a token and cryptogram) and use this information to retrieve user account details.

This arrangement is shown in FIG. 1B, which includes token service provider 15, which includes demerge module 17 and account details storage 16. Demerge module 17 in the embodiment shown receives a transaction request that includes a token and a cryptogram merged into a single data value. This transaction request may be an initial transaction request if the transaction is initiated in a way that uses the merged token/cryptogram from the outset. Alternately, the transaction request of FIG. 1B may be a retried transaction request (e.g., the “second transaction request” shown in FIG. 1A).

Demerge module 17 also receives additional transaction details as part of the request. For example, the transaction request may include a transaction identifier (ID). This information is usable by module 17 to identify the transaction to the payment services provider (shown as “request details” in FIG. 1B). In turn, the payment services provider, once the transaction is identified, can indicate (through “demerge information”) what process or protocol was used to merge the token and the cryptogram that has been received by token service provider 15. This information, in turn, allows demerge module 17 to successfully demerge the merged token/cryptogram. Once the token and cryptogram are separated by module 17, the token and cryptogram, along with any other relevant information, may be supplied to account details storage 16 in order to obtain account details (such as the user's credit or debit card number) which are then conveyed to the user's financial institution to continue processing the transaction. Accordingly, in the embodiment shown, token service provider 15 includes logic to separate a merged token/cryptogram. Note that token service provider 15 may also be configured to receive unmerged tokens/cryptograms as well. Token service provider 15 may thus be able to identify the nature of the authorization data that is received (e.g., merged or unmerged tokens and cryptograms) and act in the appropriate manner.

Although the use of a data value having a token and a cryptogram merged together is discussed above with references to FIGS. 1A and 1B and in the context of a retry based on determined risk factors, the disclosure is not limited to such an embodiment. The present disclosure also contemplates transactions in which a token and a cryptogram may be merged irrespective of any risk score, tenants, or account issuers. Accordingly, a merged token and cryptogram may be generated in the first instance when a new financial instrument is set up by a user. As used herein, a “financial instrument” refers to its ordinary meaning in the art, and includes a credit card, debit card, or any other mechanism that may be used to make payments.

In addition to functions discussed above, various embodiments of token service provider 15 may assist with a process referred to here as “onboarding.” During onboarding, a user of a device may link one or more accounts to the payment services processor and, additionally, to an application on a device (e.g., a smartphone app). Tokens are also issued to the device during the onboarding process. The onboarding process may also include generation of risk rules for the particular user/device. Upon completion of the onboarding process, the user may be issued tokens to be used in conducting transactions that involve the payment services provider.

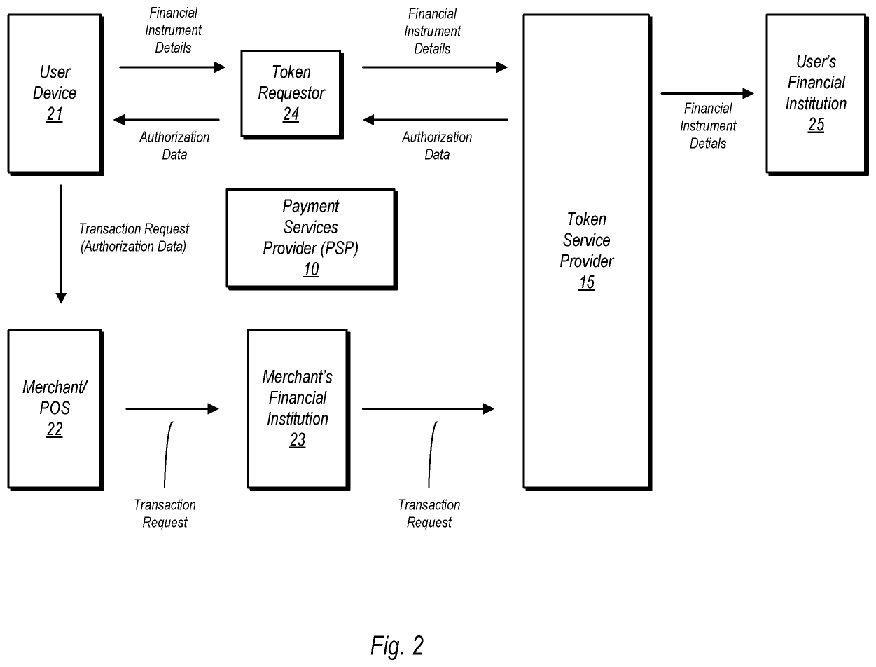

FIG. 2 is a block diagram of one embodiment of various components that may be included in a transaction involving a payment processing system. In addition to the previously discussed payment services provider 10 and token service provider 15 (and computer systems implemented thereby), the system also includes a user device 21, a merchant/point-of-sale (POS) 22, a merchant's financial institution 23, a token requestor 24, and a user financial institution 25. As with the payment services provider 10 and token service provider 15, each of the other components in the illustrated system may include one or more computing platforms that perform various processing roles in handling a transaction. In some embodiments, various components may be implemented by the same entity. For example, in some transactions, PAYPAL may be both payment services provider 10 and token service provider 15. Many different configurations are possible; FIG. 2 is utilized to demonstrate a representative flow of information.

User device 21 in the embodiment shown may be any type of computing system from which transactions may be initiated by a user. Such computing systems include (but are not limited to) various types of smart phones, tablets, laptop computer system, and desktop computer systems, among others. Irrespective of the particular embodiment, user device 21 may include at least one processor and various memory and storage units. Payment processing applications may be implemented thereon, and tokens to be used in transactions initiated by user device may also be stored within a storage unit until used. The tokens may be received from, e.g., token service provider 15, via token requestor 24. User device 21 may also execute instructions to generate cryptograms to be conveyed in conjunction with a corresponding token when a transaction is initiated.

Merchant/POS 22 may be a computing system implemented in one of a number of various forms. In one embodiment, merchant/POS may be a POS terminal that includes near field communication (NFC) functionality enabling it to communicate with a portable device (e.g., a smartphone) from which transactions may be initiated. In another embodiment, merchant/POS 22 may be implemented as a computer system at a merchant facility, or online. Generally speaking, merchant/POS 22 corresponds any type of computing system that can receive transactions requests initiated by various embodiments of user device 21 and begin the processing of such transactions.

Merchant's financial institution 23 in the embodiment shown includes one or more computer systems coupled to receive transaction requests from merchant/POS 22; these typically are computer systems of the financial institution that the merchant has chosen to receive payments on its behalf from customers. A computer system implemented in merchant's financial institution 23 may perform functions such as electronically depositing funds in a merchant account responsive to the merchant completing a sale, accessing funds from an account during a refund, and so on. In addition to communications with merchant/POS 22, merchant's financial institution may also communicate with computer systems implemented by payment services provider 10 and token service provider 15.

Token requestor 24 in the embodiment shown may receive authorization data from token service provider 15 and convey the same to user device 21. The authorization data may include tokens used in conducting transactions, and thus token requestor 24 may request tokens, from token service provider 24, on behalf of user device 21. This may occur both during the onboarding process as well as in other instances for example, when it is desirable to replenish the number of tokens stored on user device 21.

The user's financial institution 25 includes one or more computer systems of the financial institution that user has selected to settle its transactions. Among the functions provided by these computer systems are the accessing of funds/debiting a user's account, transferring of funds to be provided to a merchant responsive to an authorized transaction, recording transaction history, and so forth. In the embodiment shown, user's financial institution 25 may communicate with other components of the illustrated system through token service provider 15.

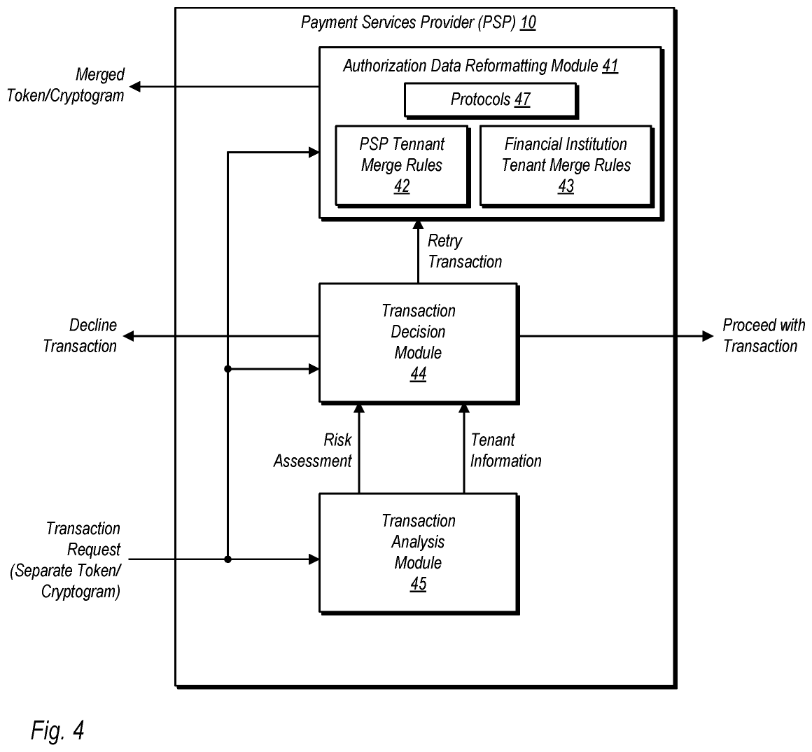

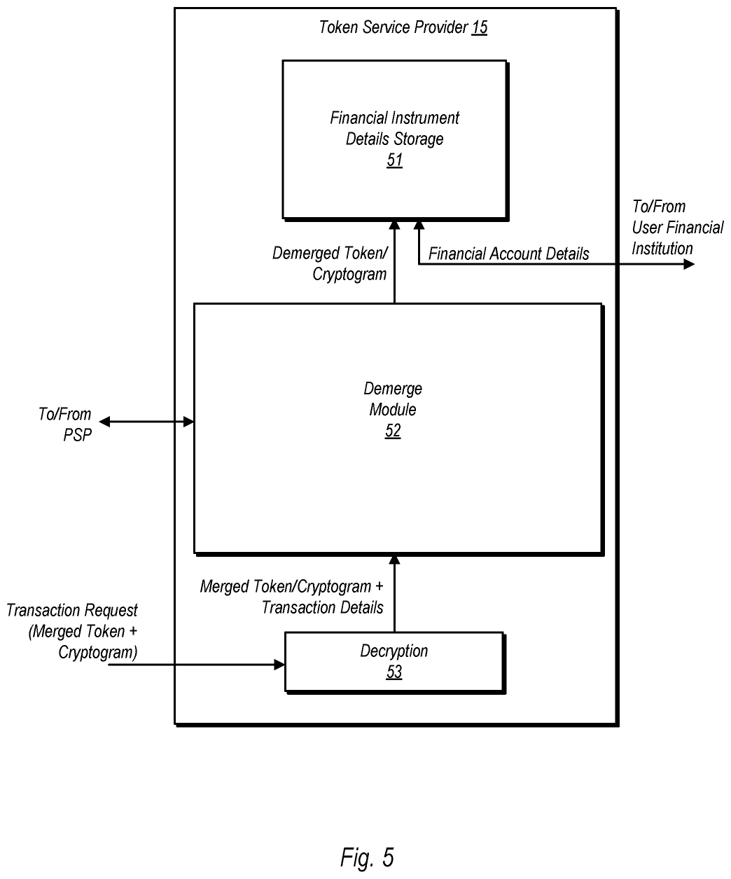

Payment services provider 10 and token service provider 15 may perform various functions such as those discussed above. Additional details regarding various embodiments of payment services provider 10 and token service provider 15 are discussed below with reference to FIGS. 4 and 5, respectively.

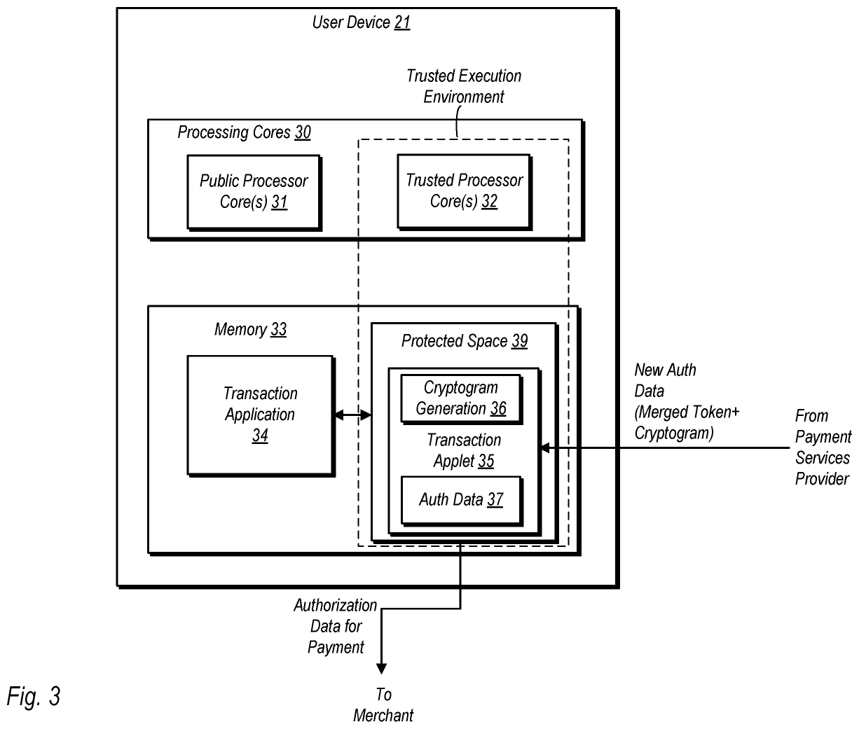

FIG. 3 is a block diagram of one embodiment of a user device from which transactions may be initiated. User device 21 may be any type of computing device from which transactions may be initiated, including (but not limited to) smart phones, tablets, laptop computers, desktop computers, and so on.

User device 21 in the embodiment shown includes a number of processor cores 30, including public processor core(s) 31 and trusted processor core(s) 32. Trusted processor core(s) 32, located within a trusted execution environment, may execute applications or portions thereof where security is paramount and where it is desirable to protect the information involved in such processing. Such applications may include payment applications, digital wallets, applications associated with a user's financial institution, password protection applications, and so on. Trusted process core(s) 32 in the embodiment shown may include certain mechanisms, such as secure registers, which may store and/or process data and which are not directly accessible by entities outside of the trusted execution environment. This may allow for protection of sensitive information, such as cryptographic keys, a user's account number, identity information (e.g., social security number), and any other information that could be used to commit identity or financial theft against the user. Public processor core(s) 31 in the embodiment shown are those that process information and execute applications that are not otherwise considered to be sensitive enough for handling by trusted processor core(s) 32.

User device 21 in the embodiment shown include memory 33. As used herein, memory 33 may refer to any medium in which data can be stored either temporarily or persistently, and may further refer to both volatile and non-volatile memory. Memory 33 may thus include dynamic random access memory (DRAM), flash memory, disk storage, and virtually any other type of memory medium that may be implemented in a computing system such as user device 21. As shown herein, memory 33 includes a protected space 39 within the trusted execution environment that is controlled separately from the remaining (unprotected) space thereof.

Memory 33 in the illustrated embodiment is shown as storing instructions of a transaction application 34. This application may be used to initiate and perform user-facing functions relative to initiating and processing a transaction. Transaction application 34 may be a PAYPAL application in some embodiments, for example. The functions provided by transaction 34 may include generating a user interface for inputting data for execution of a transaction (e.g., merchant from which a purchase is to be made, amount of the purchase, etc.). Transaction application 34 may, during execution, exchange some data with protected space 39 in memory 33.

Protected space 39 in memory 33 as shown here includes a transaction applet 35, the transaction applet being associated with transaction application 34 in the unprotected portion of memory 33. Executing transaction applet 34 includes the processing of authorization data 37 (e.g., tokens) that is used as a substitute for a user's personal account number or other financial information when a transaction is to be conducted. When a user initiates a transaction through transaction application 34, transaction applet 35 may access authorization data 37 and cause a portion thereof to be conveyed from user device to a merchant at, e.g., a merchant point of sale terminal. The initiation of a transaction through transaction application 34 may also cause transaction applet 35 to execute instructions of cryptogram generation module 36, thereby generating a cryptogram to be conveyed from user device 21 along with the authorization data for the given transaction.

Although not explicitly shown here, user device 21 may include other functional units to enable communications with other systems external thereto. These functional units may include NFC circuits, WiFi circuitry, and other types of functional circuitry to enable communications with external devices.

FIG. 4 is a block diagram of one embodiment of a computer system of a payment services provider. As described above, payment services provider 10 is a computer system that stores and executes instructions that interface with merchant systems and other entities in order to process financial transactions. Exemplary modules that may be included in provider 10 are data reformatting module 41, transaction decision module 44, and transaction analysis module 45.

Transaction analysis module 45 in the embodiment shown receives transaction requests that include authorization data—that is, data that can be used to identify personal account details of a user. In this example, the authorization data includes a token and a separately received cryptogram associated therewith, although other types of authorization data may also be received and processed by transaction analysis module 45. During a transaction, transaction analysis module 45 operates to gather or determine information about the transaction. For example, module 45 may evaluate risk associated with the transaction based on various factors (e.g., identity and history of the requestor, amount of transaction, location of transaction, etc.). This analysis may be done by module 45, or module 45 may initiate a call to an external service for such information Module 45 may also determine information about the transaction, such for example “tenant information,” which in this case may indicate a particular tenant of the payment services provider. For example, one tenant of payment services provider 10 may be a payment application like VENMO, while another tenant may be a credit or debit card. This evaluation may include a comparison of the transaction amount relative to, e.g., balance requirements or available credit, the requestor's previous transaction history with that particular tenant, and so on. Based on the analysis it performs, transaction analysis module 45 may generate a risk assessment and forward that to transaction decision module 44, along with tenant information already present as well as any corresponding additional information generated during the analysis.

Transaction decision module 44 in the embodiment shown is coupled to receive the output of module 45 (in this case, risk assessment and the tenant information), and is further coupled to receive the incoming transaction request. Based on this information, transaction decision module 44 determines how to proceed based on logic not depicted in FIG. 4. In the embodiment shown, module 44 determines whether the transaction is to proceed as received, retried with reformatted authorization data, or declined. This decision is based at least in part on information received from transaction analysis 45, which may include risk assessment information. For example, if the risk assessment provides a risk score within a first range of values, transaction decision module may determine that the transaction is to proceed. (Note that “proceed” in this context does not necessarily mean “ultimately approved”; it simply means that the transaction can continue through the payment process to the next step. Accordingly, a transaction that is allowed to proceed may not ultimately be successful.) Continuing with this example, when the risk assessment results in a risk score in a second range, transaction decision module 44 may cause the transaction to be retried with reformatted authorization data (e.g., the merged token and cryptogram as discussed herein). Still further, when the risk assessment results in a risk score in a third range, transaction decision module may cause the transaction to be declined.

Transaction decision module 44 may additionally arrive at a decision based on a variety of factors, including general information about the transaction and received tenant information. For example, if the requestor has insufficient funds or insufficient credit to complete the transaction, transaction decision module 44 can cause the transaction to be declined irrespective of any risk score. Module 44 may also cause all transaction to be retried with a merged token and cryptogram for certain financial institution tenants (e.g. all VISA card transactions, while MASTERCARD has other rules). Other limitations (e.g., number of transactions within a given time period for the particular tenant), the nature of the transaction relative to the user's transaction history, a tenant's risk tolerance, etc.) may also factor into the decision making process carried out by transaction decision module 44.

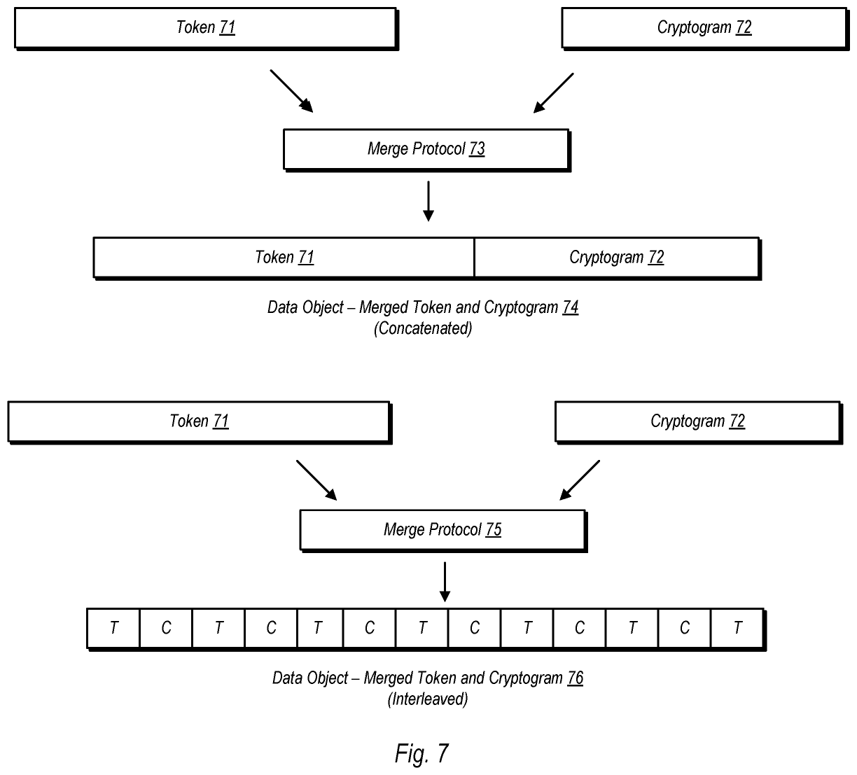

Authorization data reformatting module 41 in the embodiment shown is invoked when transaction decision module 44 determines that the transaction is to be retried with reformatted authorization data. In this particular embodiment, the reformatting of authorization data includes the merging of a token and a cryptogram, originally conveyed separately, into a common data value. The protocol for merging of the token and the cryptogram may vary from one transaction to another, and is based on various protocols included in protocols module 47 of module 41. The protocols of protocols module 47 may be derived from payment services provider merge rules 42 and financial institution tenant merge rules 43. The payment services provider tenant merge rules 42 may be those specified by a payment services provider(s) through which the transaction is being conducted. The financial institution merge rules 43 may be those specified by financial institutions involved in the transaction, specifically the financial institution of the user making the request. Based on these sets of merge rules, authorization data reformatting module 41 may determine a merge protocol and merge the token and the cryptogram in accordance therewith. The token and the cryptogram may be merged in various ways, including concatenation or interleaving. Additional details regarding merge protocols are discussed below in reference to FIG. 7.

After completing the merging of the token and the cryptogram into a common data value, authorization data reformatting module 41 conveys the merged token and cryptogram back to the device of a user from which the original transaction was initiated. From there, another request for the same transaction, using the reformatted authorization data, may be re-attempted by the user device. In many cases, the re-attempt of a transaction happens in near real-time may be performed without knowledge of the user or the merchant.

FIG. 5 is a block diagram of an embodiment of a computer system of a token service provider. In the embodiment shown, a computer system of token service provider 15 includes a decryption module 53, a demerge module 52, and a financial details storage module 51. Other components not explicitly discussed herein may also be implemented in token service provider 15.

As shown, token service provider 15 may receive a transaction request that includes a merged token/cryptogram. In some cases, this information may be encrypted, and thus is decrypted by decryption module 53. In one embodiment, token service provider 15 may query payment services provider 10 to determine the appropriate decryption technique. Alternately, token service provider 15 may already have information sufficient to determine a decryption technique. Note that the transaction request may not be encrypted, and thus decryption module 53 may not be present in those embodiments.

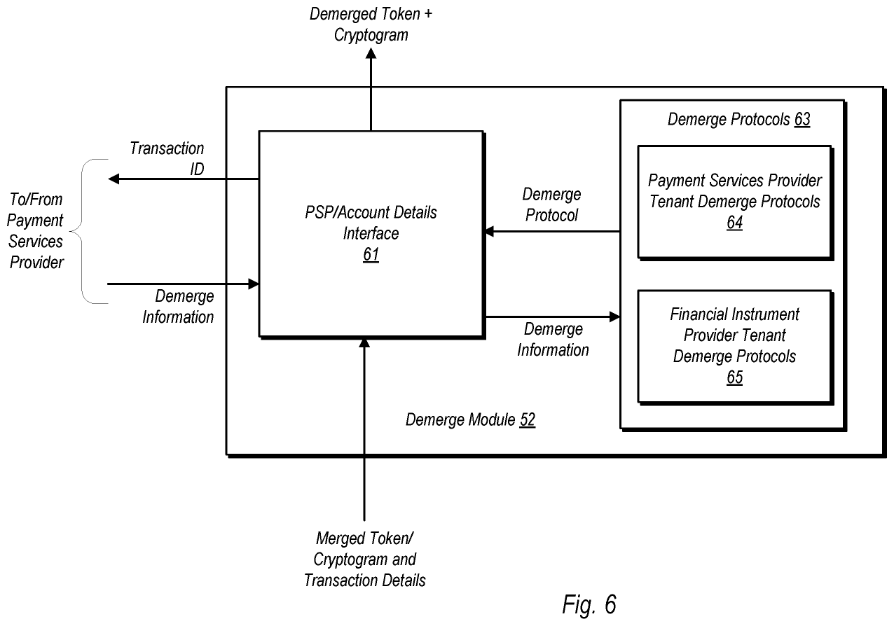

Upon completion of the decryption process by decryption module 53 (if needed), the merged token and cryptogram, along with other transaction details including, for example, transaction amount, identification and routing information for the merchant's financial institution, etc. are forwarded to demerge module 52. Demerge module 52 communicates with the payment services provider to obtain information indicating the protocol under which the token and cryptogram were originally merged. In one embodiment, a transaction identifier that is common to an initial and a retried transaction request can be used as the basis to obtain information from payment services provider 10. (This identifier may thus act as a “binder” or a linkage between the first and second formats of the authorization data.) Demerge module 52 uses information received from payment services provider 10 to demerge, or separate, the token from the cryptogram. For example, payment services provider 10 can send a software routine that token service provider 15 can execute to demerge the token and cryptogram, thus indicating which portion of the merged construct is the token and which is the cryptogram. Additional details of one embodiment of a demerge module (and other alternatives) are discussed below in reference to FIG. 6.

Upon completion of the demerging, the token and cryptogram, now separated, are used to index into financial instrument details storage 51. Using this information in the token, financial instrument details storage 51 may access financial account details for the user from the user's financial institution that have been previously stored (such as during an onboarding process). Using this information, token services provider 15 may continue its role in processing the transaction to completion.

In addition to the functions discussed above, various embodiments of token service provider 15 also serve an issuer of tokens to various user devices. This includes initial issuing of tokens (e.g., during the onboarding process discussed above), as well as to replenish a supply of tokens to a particular user device.

FIG. 6 is a block diagram of one embodiment of a demerge module implemented by a computer system of a token service provider. In the embodiment shown, demerge module 52 includes PSP/account details interface 61 and a demerge protocols module 63. The demerge protocols module 63, in this embodiment, includes both payment services provider tenant demerge protocols 64 and financial institution provider tenant demerge protocols 65.

PSP/account details interface 61 is coupled to receive a merged token and cryptogram along with transaction details from decryption module 53 as discussed above with reference to FIG. 5. (In the case that the merged token/cryptogram is unencrypted, module 53 would not be needed.) In one embodiment, the information received from the decryption module includes a transaction identifier, or transaction ID, which is usable by a payment services provider to identify the transaction in question. PSP/account details interface 61, upon receiving the merged token and cryptogram, conveys the transaction ID to the payment services provider (or PSP, as listed in the drawing). (In other embodiments, interface 61 may convey other types of information to the payment services provider; the transaction ID is just one possible example.) Using the transaction ID, the payment services provider may then determine the protocol that was used to originally merge the token (e.g., by accessing a table or other data structure storing information regarding the transaction). This information is then forwarded as demerge information to PSP/account details interface 61 from the payment services provider.

PSP/account details interface 61 forwards, upon its receipt from the payment services provider, demerge information to demerge protocols module 63. Using this information, demerge protocols module 63 may access demerge protocol information from payment services provider tenant demerge protocols module 65 and financial instrument provider tenant demerge protocols 65. As noted above in the discussion of FIG. 4, the payment services provider may use any suitable demerge protocols, including protocols relating to payment services provider tenants (e.g., VENMO) and financial instrument tenants (e.g., VISA). Examples of such protocols are described below with reference to FIG. 7. Accordingly, demerge protocols module 63 may be determined based on a variety of factors, including the payment service provider tenant for the transaction, and/or the financial instrument tenant.

Based on the information from both of the modules 64, 65 in demerge protocols modules 63, a demerge protocol may be determined and conveyed back to PSP/account details interface 61. Using this demerge protocol, PSP/account details interface 61 may separate (demerge) the token from the cryptogram. Thereafter, the demerged token and cryptogram are forwarded to financial instrument details storage 51 of FIG. 1 for further transaction processing.

Note that the demerging can be done in alternate ways. For example, interface 61 could pass the merged token/cryptogram to payment services provider 10 for actual separation, but this may create additional complexity and network traffic. Alternately, payment services provider 10 could pass back the logic routines needed to do the demerging to interface 61; such logic routines could then be implemented by demerge module 52, for example by executing a software routine that is sent by payment services provider 10. These logic routines, when carried out by demerge module 52 enable the token and the cryptogram to be separated from one another. Any suitable merge/demerge protocol, such as those discussed below with reference to FIG. 7, may be used. Alternatively, payment services provider 10 can pass back an identifier that indicates a demerge protocol that is already stored within or accessible to module 52, wherein the demerge protocol defines a process that is the reverse of that used to initially merge the token and the cryptogram.

FIG. 7 is a block diagram illustrating examples of various protocols for merging a token and a cryptogram into a single data value. In particular, FIG. 7 illustrates two different mechanisms by which a token and a cryptogram may be merged, although the examples here are not intended to be limiting. On the contrary, the present disclosure contemplates a wide variety of mechanisms by which a token and a cryptogram can be merged in accordance with this disclosure.

One mechanism by which a token and a cryptogram can be merged is concatenation, which is shown in the upper portion of FIG. 7. In this example, token 71 and cryptogram 72 are merged according to merge protocol 73, which is a concatenation protocol, meaning that cryptogram 72 is appended to the end of token 71 (or vice-versa). As shown, using protocol 73, token 71 and cryptogram 72 are combined “end-to-end” into data value 74.

In the lower portion of FIG. 7, token 71 and cryptogram 72 are merged in accordance with merge protocol 75. In this case, merge protocol 75 causes portions of token 71 and cryptogram 73 to be interleaved with one another. The manner of interleaving may vary from one embodiment to another, and within a system according to this disclosure, a large number of interleaving schemes may be utilized. In one example, assuming the token and cryptogram have the same number of characters, a character associated with token 71 may be followed by a character of cryptogram 72, followed by another character of token 71, and so on. When token 71 and cryptogram 72 are not of equal size, this type of interleaving may occur for a number of characters equal to the smaller of the two entities.

In another embodiment, interleaving may be conducted (more generally) by arranging a first number of characters of token 71 followed by a second number of characters of cryptogram 72, wherein the first and second numbers may be different from one another (e.g., two characters from token 72 followed by a single character of cryptogram 73). More complex merge protocols are also contemplated (e.g., three characters of token, two characters of cryptogram, one character of token, three characters of cryptogram, and so on). Furthermore, for a given tenant or set of tenants, the merge protocol may be varied from one instance to the next, or changed periodically. Such variation in a merge protocol may provide an additional layer of security on top of the fact that token and cryptogram are merged into a single data object. Also note that some tokens and cryptogram (e.g., for some tenants) may be merged, while others may not.

With regard to the previously discussed concatenation, additional variation of merge protocols is possible with this mechanism as well. For example, instead of the arrangement shown in FIG. 7, the end of cryptogram 72 may be coupled to the beginning of token 71. Furthermore, for a given tenant, this arrangement can be varied from one instance to the next. It is also contemplated that concatenation may be such that one of the entities (the token or the cryptogram) may remain contiguous while the other entity is placed in the data object in two separate parts. For example, a contiguous cryptogram could be placed between a first portion of the token and a second portion of the token.

Generally speaking, the present disclosure contemplates a significant amount of variation in the various ways a token and a cryptogram can be merged into a single data object. The present disclosure further contemplates that particular tenants can vary their own merge rules from time to time, e.g., from one merge operation to the next, daily, weekly, and so on. By varying the rules by which a token and a cryptogram can be merged, as well as changing these merge rules at specified times for given tenants, security of the merged data object may be further enhanced.

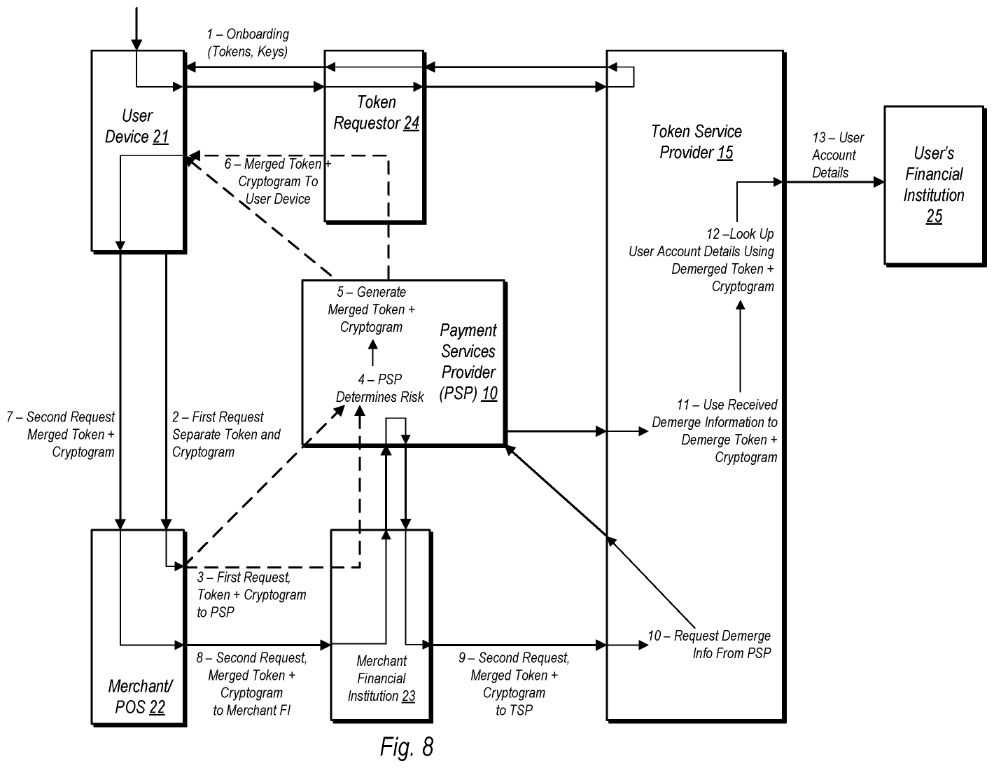

FIG. 8 is a block diagram illustrating an exemplary flow of a transaction that is first attempted with a separate token and cryptogram, followed by a second attempt with the token and cryptogram merged in a single data value. It is noted that this example is but one possibility of a transaction falling within the scope of this disclosure, and is not intended to be limiting. For example, embodiments falling within the scope of this disclosure may include systems that process transactions in which the token and cryptogram are merged at the outset, rather than after a security risk determination.

The process shown in FIG. 8 begins with the procedure known as “onboarding,” as previously discussed above (‘1’ in the drawing). The onboarding procedure includes linking accounts to the payment services provider and an application on user device 21, as well as receiving tokens. This is accomplished through token requestor 24 and token service provider 15. As also discussed above, the onboarding process can include the generating of risk rules for the particular user and/or device. The generation of risk rules can include determining risk factors associated with the account, or user, including information such as credit scores, balances, transaction history and so on.

In ‘2’, a first request for a transaction is sent from user device 21 to merchant/POS 22. In the first request, a token issued to user device 21 may be sent to merchant/POS 22. Separately, a cryptogram generated on user device 21 is also sent to merchant/POS 22, e.g., by the transaction applet 35 (and in particular, cryptogram generation module 36) as shown in FIG. 3. The cryptogram is subsequently used to verify the transaction later in the process, as discussed below.

In ‘3’, the first request, including the token and the cryptogram, are sent to the payment services provider 10. The request may be sent directly to payment services provider 10 from merchant/POS 22, or alternatively, through merchant financial institution 23. Thereafter, at ‘4’, payment services provider 10 performs analysis, which may include a determination of risk associated with the transaction. In this particular example, payment services provider 10 may determine that, based on the analysis, a retry of the transaction is needed. Accordingly, at ‘5’, payment services provider 10 generates a single data value that include the merging of the token and the cryptogram. Thereafter, the single data value is conveyed to user device 21 (at ‘6’), either directly from payment services provider 10 or via token requestor 24. (Alternately, payment services provider 10 may instruct user device 21 to generate the single data value with the merged token/cryptogram.)

At ‘7’, a second request for the transaction is sent from user device 21 to merchant/POS 22, where the second request includes the merged token and cryptogram. Merchant/POS 22 then, at ‘8’, conveys the second request to the merchant financial institution 23. From merchant financial institution 23, the merged token and cryptogram is sent to payment services provider 10 (or merchant/POS 22 may communicate directly with payment services provider 10). Seeing the token and cryptogram as a single data value, payment services provider 10 returns the single data value to merchant financial institution 23. At ‘9’, merchant financial institution 23 forwards the data value having the merged token and cryptogram to token service provider 15.

At ‘10’, token service provider 15 communicates with payment service provider 10 to determine demerge information. The demerge information may include the protocol(s) under with the original merging occurred (e.g., merging by concatenating, interleaving, etc.). Thereafter, at ‘11’, token service provider 15 uses the demerge information to demerge the token and the cryptogram back into separate entities. Upon completing the demerging, token service provider 15 continues processing the transaction using the demerged token and cryptogram. This includes, at ‘12’, using the information in the token, as verified by the cryptogram, to look up account details of the user account. Token service provider 15 the, at ‘13’, sends the user account details to the user's financial institution 25. The user's account can then be charged, debited, or otherwise accessed in a suitable manner to enable completion of the transaction.

As previously noted, some transactions may, upon initiation, include the single data value having the merged token and cryptogram. Accordingly, in such transactions, some of the various processes shown in FIG. 8 may be skipped, such as the first security check at ‘4’, the generation of the merged token and cryptogram at ‘5’ (as this was completed before the transaction request in this case) and the conveying back to user device 21 the merged toke and cryptogram, at ‘6’. The disclosure thus contemplates that, in some cases, user device 21 may have one or more instances of a data value having a merged token and cryptogram stored thereon prior to initiating a transaction.

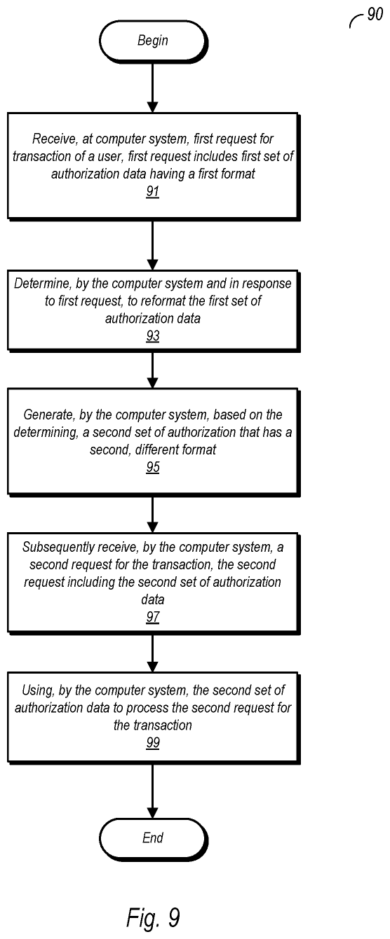

FIG. 9 is a flow diagram illustrating one embodiment of a method for conducting a transaction from the perspective of a computer system of a payment services provider. Method 90 as discussed herein may be performed by any of the various system discussed above and illustrated in FIGS. 1-8. It is further contemplated that other systems may also be capable of performing method 90, and thus these system may fall within the scope of this disclosure.

Method 90 includes receiving, at a computer system of a payment services provider, a first request for a transaction of a user, wherein the first request includes a first set of authorization data that has a first format (block 91). For example, payment services provider 10 discussed in various embodiments above may receive a request having a token and a cryptogram that is conveyed separately from the token. The method further includes determining, by the computer system in response to the first request, to reformat the first set of authorization data (block 93). This determination may be made by, e.g., transaction decision module 44 as shown in FIG. 4. Thereafter, method 90 includes generating, by the computer system based on the determining, a second set of authorization data that has a second, different format (block 95), which may be performed by, e.g., authorization data reformatting module 41 of FIG. 1. Method 90 further includes sending, by the computer system, the second set of authorization data to a device of the user and subsequently receiving, by the computer system, a second request for the transaction, wherein the second request includes the second set of authorization data (block 97). Method 90 concludes with using, by the computer system, the second set of authorization data to process the second request for the transaction (block 99).

In one embodiment, the first set of authorization data is generated at the device of the user (e.g., see cryptogram generation module 36 of FIG. 3). The first format of the first set of authorization data includes a first token usable by a token service provider to identify a financial instrument of the user and a first cryptogram for the first request, wherein the first cryptogram is included as a separate value within the first set of authorization data. Examples of a first token and a first cryptogram are shown in, e.g., FIG. 7, and more particularly, the separate token 71 and cryptogram 72. The second format of the second set of authorization data includes a common data value that includes a second token merged with a second cryptogram, wherein the second token is usable by the token service provider to identify the financial instrument of the user. Examples of the common data value discussed herein included the merged token and cryptogram, either by concatenation or interleaving, also shown in FIG. 7.

Determining to reformat the first set of authorization data is based on at least one merge factor selected from the group including a risk assessment associated with the transaction, a tenant of the payment services provider, and a type of a financial instrument used by the user to initiate the transaction. These actions may be performed by, in one embodiment, transaction decision module 44 of FIG. 4, which may store the listed information in the group. Generating the second set of authorization data includes merging a token and a cryptogram into a common data value. The merging is performed according to a merge protocol that is selected from a plurality of merge protocols based on particular tenant of the payment services provider identified in the transaction, and/or according to a merge protocol that is selected from a plurality of merge protocols based on a type of financial instrument used by the user to initiate the transaction. Examples of this are discussed above with reference to authorization data reformatting module 41 (and the modules implements therein) as shown in FIG. 4.

In one embodiment, the merging is performed according to a selected one of a plurality of merge protocols that includes concatenating the token and the cryptogram in the common data value. In another embodiment, the merging is performed according to a selected one of a plurality of merge protocols that includes interleaving the token and the cryptogram in the common data value. FIG. 7 and its corresponding discussion provides examples of these merge protocols.

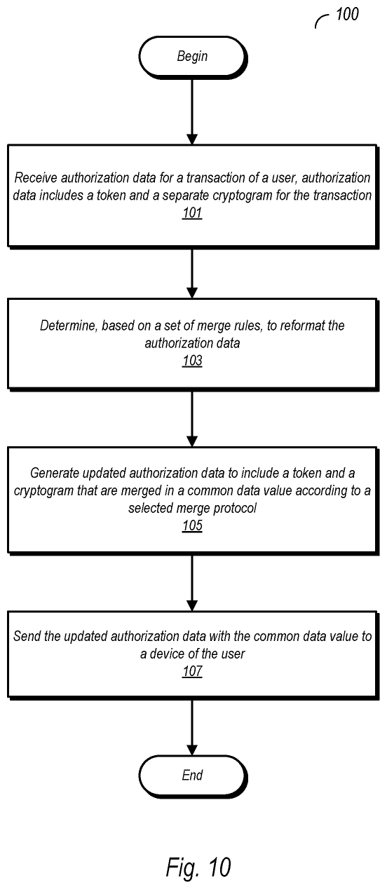

FIG. 10 is a flow diagram illustrating an embodiment of a method for merging a token and a cryptogram into a common data value. The various operations carried out in method 100 as shown in FIG. 10 may be performed by a computer system executing instructions stored on a non-transitory computer readable medium.

Method 100 includes receiving authorization data for a transaction of a user, wherein the authorization data includes a token and separate cryptogram for the transaction (block 101). An example of this may be found in FIG. 8, at ‘3’, where the first request having a token and a cryptogram, conveyed separately from one another, is received at payment services provider 10. The method further includes determining, based on a set of merge rules, to reformat the authorization data (block 103; e.g., see ‘4’ in FIG. 8 and its corresponding description above). Method 100 further includes generating updated authorization data to include a token and a cryptogram that are merged in a common data value according to a selected merge protocol and sending the updated authorization data with the common data value to a device of the user (blocks 105 and 107, respectively; e.g., see ‘5’ and ‘6’ of FIG. 8 and corresponding description above).

In various embodiments, the set of merge rules includes a rule that is based on a risk assessment for the transaction. These merge rules can be found in, e.g., PSP tenant merge rules 42, financial institution merge rules 43, or both, of FIG. 4. The selected merge protocol is selected based on an identified tenant of a payment services provider for the transaction, on a type of financial instrument used by the user to initiate the transaction, or a combination thereof. In various embodiments, the operations include subsequently receiving the updated authorization data and providing an indication that permits the transaction to proceed (e.g., see FIG. 8, at ‘8’ and ‘9’).

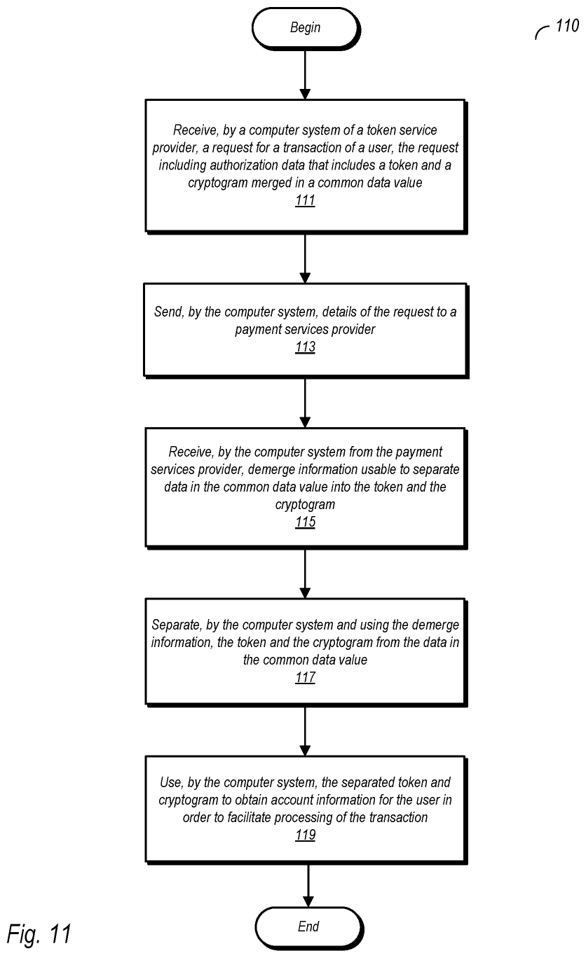

FIG. 11 is a flow diagram illustrating embodiment of a method for conducting a transaction from the perspective of a computer system in a token service provider. Method 110 as discussed herein and illustrated by FIG. 11 may be performed by various embodiment of a token service provider and elements thereof as discussed in, e.g., FIGS. 2, 5, 6 and 8.

Method 110 includes receiving, by a computer system of a token service provider, a request for a transaction of a user, wherein the request includes authorization data that includes a token and a cryptogram merged in a common data value (block 111) and sending, by the computer system, details of the request to a payment services provider (block 113). The method further includes receiving, by the computer system from the payment services provider, demerge information usable to separate data in the common data value into the token and the cryptogram (block 115). Demerging is performed by separating, using the computer system and the demerge information, the token and the cryptogram from the data in the common data value (block 117). Method 110 also includes with using, by the computer system, the separated token and cryptogram to obtain account information for the user in order to facilitate processing the transaction (block 119).

In various embodiments, the details of the request include a transaction identifier usable by the payment services provider to identify the transaction and specify the demerge information for transmission to the token services provider (e.g., the transaction ID conveyed from element 61 of FIG. 6). The demerge information includes a demerge protocol usable to separate the token and cryptogram from data in the common data value. The demerge protocol is executable to de-interleave the token and cryptogram in a manner particular to either an identified tenant of the payment services provider for the transaction, or a type of financial instrument used to initiate the transaction.

Although not explicitly shown herein, it is possible that in some embodiments, the token services provider and the payment services provider are the same entity. In such embodiments, the same computer system may be used, or different computer systems within the same entity.

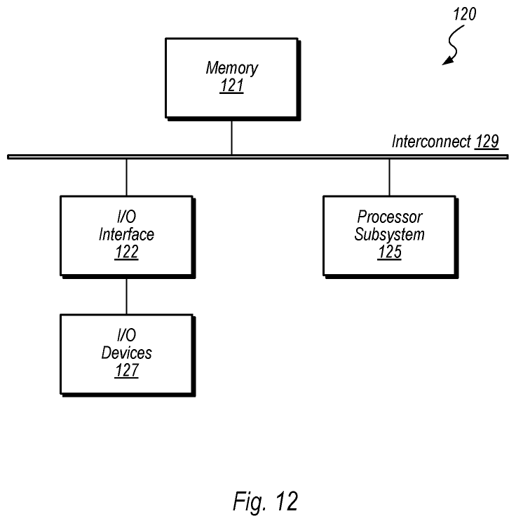

FIG. 12 is a block diagram of one embodiment of an example computer system. Instances of computer system 120 as shown here may be implemented, in various embodiments, at payment services provider 10, token service provider 15, and in other elements of the various systems discussed above.

Computer system 120 includes a processor subsystem 125 that is coupled to a system memory 121 and I/O interfaces(s) 122 via an interconnect 129 (e.g., a system bus). I/O interface(s) 122 is coupled to one or more I/O devices 127. Computer system 120 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 120 is shown in FIG. 10 for convenience, system 120 may also be implemented as two or more computer systems operating together.

Processor subsystem 125 may include one or more processors or processing units. In various embodiments of computer system 120, multiple instances of processor subsystem 125 may be coupled to interconnect 129. In various embodiments, processor subsystem 125 (or each processor unit within 125) may contain a cache or other form of on-board memory.

System memory 121 is usable store program instructions executable by processor subsystem 125 to cause system 120 perform various operations described herein. System memory 121 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 120 is not limited to primary storage such as memory 121. Rather, computer system 120 may also include other forms of storage such as cache memory in processor subsystem 125 and secondary storage on I/O Devices 127 (e.g., a hard drive, storage array, etc.). In some embodiments, these other forms of storage may also store program instructions executable by processor subsystem 125. In some embodiments, memory 121 may include various ones of the modules discussed above, such transaction decision module 44 of FIG. 4 when implemented in payment services provider 10, demerge module 15 of token service provider 15, and so on.

I/O interfaces 122 may be any of various types of interfaces configured to couple to and communicate with other devices, according to various embodiments. In one embodiment, I/O interface 122 is a bridge chip (e.g., Southbridge) from a front-side to one or more back-side buses. I/O interfaces 122 may be coupled to one or more I/O devices 127 via one or more corresponding buses or other interfaces. Examples of I/O devices 127 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 120 is coupled to a network via a network interface device 127 (e.g., configured to communicate over WiFi, Bluetooth, Ethernet, etc.).

Numerous variations and modifications will become apparent to those skilled in the art once the above disclosure is fully appreciated. It is intended that the following claims be interpreted to embrace all such variations and modifications.

What is claimed is:

1. A method, comprising:
receiving, at a computer system of a payment services provider, a first request for a transaction of a user, wherein the first request includes a first set of authorization data that has a first format;
determining, by the computer system in response to the first request, to reformat the first set of authorization data;
generating, by the computer system based on the determining, a second set of authorization data that has a second, different format;
sending, by the computer system, the second set of authorization data to a device of the user;
subsequently receiving, by the computer system, a second request for the transaction, wherein the second request includes the second set of authorization data; and
using, by the computer system, the second set of authorization data to process the second request for the transaction.

2. The method of claim 1, wherein the first set of authorization data is generated at the device of the user.

3. The method of claim 1, wherein the first format of the first set of authorization data includes:
a first token usable by a token service provider to identify a financial instrument of the user; and
a first cryptogram for the first request, wherein the first cryptogram is included as a separate value within the first set of authorization data.

4. The method of claim 3, wherein the second format of the second set of authorization data includes a common data value that includes a second token merged with a second cryptogram, wherein the second token is usable by the token service provider to identify the financial instrument of the user.

5. The method of claim 1, wherein determining to reformat the first set of authorization data is based on at least one merge factor selected from a group including: a risk assessment associated with the transaction, a tenant of the payment services provider, and a type of a financial instrument used by the user to initiate the transaction.

6. The method of claim 5, wherein generating the second set of authorization data includes merging a token and a cryptogram into a common data value.

7. The method of claim 6, wherein the merging is performed according to a merge protocol that is selected from a plurality of merge protocols based on particular tenant of the payment services provider identified in the transaction.

8. The method of claim 6, wherein the merging is performed according to a merge protocol that is selected from a plurality of merge protocols based on a type of financial instrument used by the user to initiate the transaction.

9. The method of claim 6, wherein the merging is performed according to a selected one of a plurality of merge protocols that includes concatenating the token and the cryptogram in the common data value.

10. The method of claim 6, wherein the merging is performed according to a selected one of a plurality of merge protocols that includes interleaving the token and the cryptogram in the common data value.

11. A non-transitory, computer-readable medium having instruction stored thereon that are capable of execution by a computer system to perform operations comprising:
receiving authorization data for a transaction of a user, wherein the authorization data includes a token and separate cryptogram for the transaction;
determining, based on a set of merge rules, to reformat the authorization data;
generating updated authorization data to include a token and a cryptogram that are merged in a common data value according to a selected merge protocol; and
sending the updated authorization data with the common data value to a device of the user.

12. The computer-readable medium of claim 11, wherein the set of merge rules includes a rule that is based on a risk assessment for the transaction.

13. The computer-readable medium of claim 11, wherein the selected merge protocol is selected based on an identified tenant of a payment services provider for the transaction.

14. The computer-readable medium of claim 11, wherein the selected merge protocol is selected based on a type of financial instrument used by the user to initiate the transaction.

15. The computer-readable medium of claim 11, the operations further comprising:
subsequently receiving the updated authorization data; and
providing an indication that permits the transaction to proceed.

16. A method, comprising:
receiving, by a computer system of a token service provider, a request for a transaction of a user, wherein the request includes authorization data that includes a token and a cryptogram merged in a common data value; and
sending, by the computer system, details of the request to a payment services provider;
receiving, by the computer system from the payment services provider, demerge information usable to separate data in the common data value into the token and the cryptogram;
separating, by the computer system using the demerge information, the token and the cryptogram from the data in the common data value; and
using, by the computer system, the separated token and cryptogram to obtain account information for the user in order to facilitate processing the transaction.

17. The method of claim 16, wherein the details of the request include a transaction identifier usable by the payment services provider to identify the transaction and specify the demerge information for transmission to the token services provider.

18. The method of claim 16, wherein the demerge information includes a demerge protocol usable to separate the token and cryptogram from data in the common data value.

19. The method of claim 18, wherein the demerge protocol is executable to de-interleave the token and cryptogram in a manner particular to either an identified tenant of the payment services provider for the transaction, or a type of financial instrument used to initiate the transaction.

20. The method of claim 16, wherein the token services provider and the payment services provider are the same entity.
